(19) United States
(12) Patent Application Publication
(10) Pub. No.: US 2013/0219296 A1
(43) Pub. Date: Aug. 22, 2013

(54) REAL TIME EDITING FOR ELECTRONIC MAIL

(71) Applicants: Sudeep Mathew Thazhmon, Winter Garden, FL (US); Lance Jackson, Lake Mary, FL (US)

(72) Inventors: Sudeep Mathew Thazhmon, Winter Garden, FL (US); Lance Jackson, Lake Mary, FL (US)

(21) Appl. No.: 13/400,155

(22) Filed: Feb. 20, 2012

(51) Int. Cl. G06F 3/01; G06F 15/16

(52) U.S. Cl. 715/752

(57) ABSTRACT

Methods and apparatus, including computer program products, for real time editing for electronic mail. A method includes, in a network, establishing a session between an email client and an email server, loading a legacy email message in the email client, receiving a live edit selection, converting contents of the legacy email message into a set of revisions, sending the set of revisions to the email server with an identifier created using a hashing algorithm on parts of the legacy email message header and body, comparing the identifier with current live emails to determine if the legacy email message has been edited previously, if the identifier is not found, generating a new live email with a master revision line containing the initial set of revisions, if the identifier is found, adding the revisions to a master revision line in the preexisting live email, and sending the live email content back to the email client where it replaces the legacy email.

### BACKGROUND OF THE INVENTION

The invention generally relates to networks and network applications, and more specifically to real time editing for electronic mail (email).

Email, in today's age has become one of the most widely used internet application. You can send messages to the other people who are connected with each other through a network. Most of the people in business, government and education prefer using email in comparison to conventional mail which is also known as snail mail for communicating with their colleagues. Email has contributed a lot to the growth of internet as it has brought close together families and friends that are scattered all around the world. As email has come into picture, the task of sending and receiving messages has become very easy. It also eliminates time delays and the other problem which you can face if the message will be delivered physically. It is used frequently in our day to day life now as it is very simple to use. The protocols which are used to deal with email are SMTP (Simple Mail Transfer Protocol), POP (Post Office Protocol) and IMAP (Internet Message Access Protocol). SMTP protocol is used to transfer the messages over a network and also gives an indication of incoming messages. POP protocol is used to enable the users to move their emails from mail server to their computers. It works in offline access mode. It is just like a real post office, which collects all the pending mails from the mail server to the user's own computer. IMAP protocol enables a user to manipulate email messages in the server without downloading them to the user's own computer. You can view just the heading and the sender of the email and then you can decide what you want to do with the message. Whether you want to download it or want to delete it.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for real time editing for electronic mail (email).

In general, in one aspect, the invention features a method including, in a network, establishing a session between an email client and an email server, loading a legacy email message in the email client, receiving a live edit selection, converting contents of the legacy email message into a set of revisions, sending the set of revisions to the email server with an identifier created using a hashing algorithm on parts of the legacy email message header and body, comparing the identifier with current live emails to determine if the legacy email message has been edited previously, if the identifier is not found, generating a new live email with a master revision line containing the initial set of revisions, if the identifier is found, adding the revisions to a master revision line in the preexisting live email, and sending the live email content back to the email client where it replaces the legacy email.

In another aspect, the invention features a method including, in a network, establishing a session between an email client and an email server, loading a legacy email message in the email client, receiving a draft edit selection, converting contents of the legacy email message into a set of revisions, storing edits made to the legacy email as additional revisions in a local revision line, receiving a send instruction from the email client, sending the set of revisions to the email server with an identifier created using a hashing algorithm on parts of the legacy email message header and body, comparing the identifier with current live emails to determine if the legacy email message has been edited previously, if the identifier is not found, generating a new live email with a master revision line containing the initial set of revisions, if the identifier is found, adding the revisions to a master revision line in the preexisting live email, and sending the live email content back to the email client where it replaces the legacy email.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram of an exemplary network.

FIG. 2 is a block diagram.

FIG. 3 is a block diagram.

FIGS. 4-8 are exemplary user interfaces.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” “module,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Email (electronic mail) is an exchange of computer-stored messages by telecommunication. Email messages are usually encoded in ASCII text. However, one can also send non-text files, such as graphic images and sound files, as attachments sent in binary streams. Email is one of the protocols included with the Transport Control Protocol/Internet Protocol (TCP/IP) suite of protocols. A popular protocol for sending email is Simple Mail Transfer Protocol (SMPT) and a popular protocol for receiving it is Post Office Protocol 3 (POP3).

In general, a message sender uses email software, called a client, to compose a document, possibly including attachments such as tables, photographs or even a voice or video recording. System software, called Transmission Control Protocol (TCP), divides the message into packets and adds information about how each packet should be handled, e.g., in what order packets were transmitted from the sender. Packets are sent to a mail submission server, a computer on an internal network of a company or an Internet service provider.

Internet mail addresses are attached to each message are in the form “mailbox@domainname;” one example is “user1@hotmail.com.” The multipart domain name in the above example denotes a top-level domain (“.com”) following the second-level domain (“hotmail”). A message is delivered to an individual by the mailbox name (“user1).

A mail submission server converts the domain name of the recipient's mail address into a numeric Internet Protocol (IP) address. It does this by querying domain name servers interspersed throughout the Internet.

Routers dispersed throughout the Internet read the IP address on a packet and relay it toward its destination by the most efficient path. A destination mail server places the packets in their original order, according to the instructions contained in each packet, and stores the message in the recipient's mailbox. The recipient's client software can then display the message.

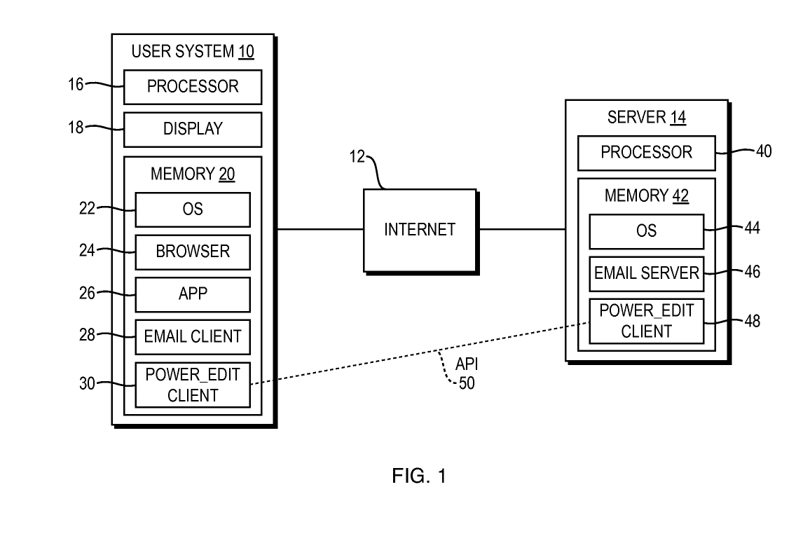

As shown in FIG. 1, an exemplary user system 10 is linked to a network of interconnected computers (e.g., the Internet) 12 through a wired or wireless link. The Internet 12 includes a server 14. The user system 10 includes a processor 16, display 18 and a memory 20. Memory 20 includes an operating system 22, such as Linux®, Android® or Windows®, and a browser process 24, such as Firefox®, Chrome® or Opera®. Memory 20 may also include a native email application 26, such as Outlook®. The browser process 24 and the native email application 26, if present, enable a user to interact with the server 14 through an email client 28 having a power_edit client 30. Example servers include Yahoo!®, Gmail®, and Hotmail®.

The server 14 includes a processor 40 and a memory 42. Memory 42 includes an operating system 44, such as Linux® or Windows®, and an email server 46 having a power_edit server 48.

Both the power_edit client 30 and the power_edit server 48 may be installed as realtime editing clients/servers, such as, code, code libraries, addons, addins, plugins and so forth.

The email client 28 and email server 46 enable a user to read, edit and delete legacy email messages. The power_edit client 30 and the power_edit server 48 enable live editing of legacy emails after they have been sent and draft editing of legacy emails after they have been sent.

Live editing and draft editing are additional features added by the present invention to legacy email systems, such as those mentioned above, like Gmail® and Outlook®. When the power_edit client 30 and the power_edit server 48 are installed, the user of a legacy email system is visually presented in any legacy email with the standard options of read, reply, reply all, forward and delete, and the additional options of live edit and draft edit. The power_edit server 48 may be associated with the email server 46 or integrated within the email server 46.

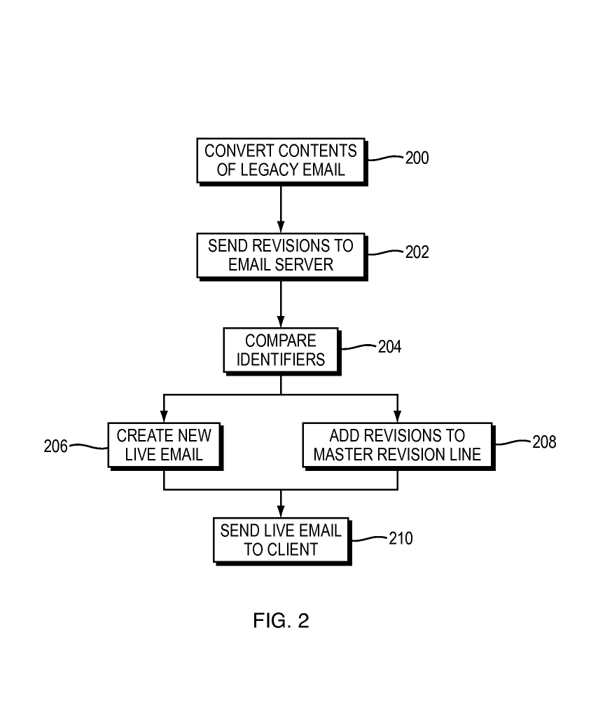

As shown in FIG. 2, when a user selects “live edit” on a legacy email, the email client 28/power_edit client 30 converts (200) the contents of the legacy email into a set of revisions, including the participants (i.e., sender or recipients), subject, and other email header information, as well as the rich text content of the email. These revisions are sent (202) to the power_edit server 48/email server 46 with an identifier created by using a hashing algorithm on parts of the email header and body. Communication between the power_edit client 30 and the power_edit server 48 occurs over a power_edit client/server API 50.

The power_edit server 48/email server 46 compares (204) the identifier with all current live emails to determine if this email has been edited previously. If the identifier is not found, a new live email is created (206) with a master revision line containing the initial set of revisions.

If the identifier is found (indicating that the legacy email has already been edited by another user), the revisions are added (208) to the master revision line in the preexisting live email.

The corresponding live email content is sent (210) back to the email client 28/power_edit client 30 where it replaces the legacy email after an automatic screen refresh.

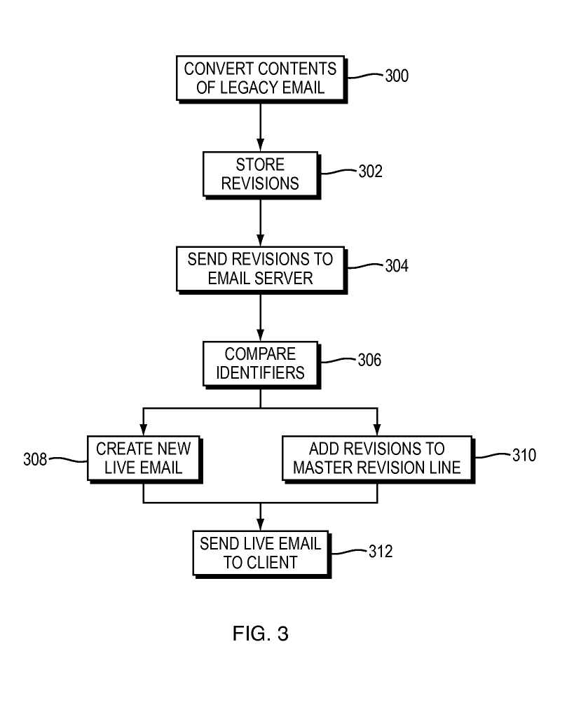

As shown in FIG. 3, when the user selects “draft edit” on a legacy email, the email client 28/power_edit client 30 converts (300) the contents of the email into a set of revisions, including the participants (i.e., sender or recipients), subject, and other email header information, as well as the rich text content of the email. Edits made to the email are stored (302) as additional revisions in the local revision line. Once the user selects “send” these revisions are sent (304) to the power_edit server 48/email server 46 with an identifier created by using a hashing algorithm on parts of the email header and body. Communication between the power_edit client 30 and the power_edit server 48 occurs over a power_edit client/server API 50.

The power_edit server 48/email server 46 compares (306) the identifier with all current live emails to determine if this email has been edited previously. If the identifier is not found, a new live email is created (308) with a master revision line containing the initial set of revisions.

If the identifier is found (indicating that the legacy email has already been edited by another user), the revisions are added (310) to the master revision line in the preexisting live email.

While the email client 28/power_edit client 30 is displaying a live email, any local revisions made to that email are applied to a new temporary revision line for that live email, displayed to the user, and sent immediately to the power_edit server 48/email server 46. These revisions can include changes to the participants in the email, changes to the rich text body of the email, comments or discussion threads in addition to the email content, and editing/markup information. Revisions have an author which identifies which user was responsible for the changes contained in that revision.

The power_edit server 48/email server 46 applies these revisions to the master revision line, transforming them if necessary. Revisions need to be transformed when multiple clients are editing the same live email simultaneously, and the changes have not yet been propagated back to the clients. The power_edit server 48/email server 46 then sends (312) a response along with any transformed revisions back to the email client 28/power_edit client 30.

Upon receiving the server response the client applies any transformed revisions and merges the temporary revision line back into the local revision line for the live email. Any revisions made to the live email by other clients are propagated from the server and applied by the client to the local revision line for that live email. If a temporary revision line exists the revisions in that line are transformed against the incoming revisions to reflect the changes made to the live email.

When the user selects “draft edit” on a live email, the local revisions made to the email are applied to a new temporary revision line for that live email and displayed to the user, but the revisions are not sent to the power_edit server 48/email server 46. Once the user selects “send” the revisions in the local revision line for the live email are submitted to the power_edit server 48/email server 46.

The power_edit server 48/email server 46 applies these revisions to the master revision line, transforming them if necessary. Revisions need to be transformed when multiple clients are editing the same live email simultaneously, and the changes have not yet been propagated back to the clients. The power_edit server 48/email server 46 then sends a response along with any transformed revisions back to the email client 28/power_edit client 30.

Upon receiving the server response the client applies any transformed revisions and merges the temporary revision line back into the local revision line for the live email. Any revisions made to the live email by other clients are propagated from the server and applied by the client to the local revision line for that live email. If a temporary revision line exists the revisions in that line are transformed against the incoming revisions to reflect the changes made to the live email.

The email client 28/power_edit client 30 can query the power_edit server 48/email server 46 for revisions to a live email based on version numbers. The email client 28/power_edit client 30 maintains a list of which versions of a live email have been viewed, and can then request the list of revisions which have occurred since that version. These revisions can be displayed to the user to show changes that have been made to the live email since it was last viewed.

The email client 28/power_edit client 30 can step through the revisions to display sequences of changes to the user. This enables changes to be replayed in either a forward or backward direction displaying to the user the change history of the live email.

Receiving the live edit selection can include displaying a live edit button on a dashboard on user interface adjacent to standard email buttons and receiving an indication that the live edit button has been selected. Receiving the draft edit selection can include displaying a draft edit button on a dashboard on user interface adjacent to standard email buttons, and receiving an indication that the draft edit button has been selected.

The revisions can include a comment on a specific section of the legacy email. The comment may be stored as a thread in a string of comments.

The revisions can include an inserted application and recipient can view the inserted application.

The contents of the legacy email message can include participants, subject, email header information, and rich text content of the legacy email.

The email client can include a real time editing client and the email server can include a real time editing server. The real time editing client and the real time editing server may include addins, addons, plugins, code, code libraries, and so forth. Communication between the real time editing client and the real time editing server can be over an application programming interface (API).

The process may also include stepping through the revisions to display sequences of changes, and stepping can be either in a forward or a backward direction enabling display of a change history of the live email.

The process can also include querying the email server for revisions to the live email based on version numbers.

In implementations, the process can maintain a list of which versions of the live email have been viewed and display changes that have been made to the live email since it was last viewed. The changes can be highlighted and originate from multiple participants.

The email client can include a real time editing client enabled to reply to the email and merge revisions into a real time version of the email and enable transforming a revision into the legacy email and sending the legacy email to one or more recipients who do not have the realtime editing client. A reply can be merged from a recipient of the email who does not have the realtime editing client into a real time version of the email.

The changes can include indications of participants who modified parts of an email. The changes can include one or more limitations on an edit behavior of a recipient, the one or more limitations stored as metadata. The edit behavior can include one or more can edit and comment, one or more can only comment, one or more cannot hit ReplyAll, and one or more cannot do any modifications. The changes can include change to participants of an email after it has been sent. The list can be ordered by minute, hour, day, week, month, and year.

In another implementation, the process may generate a live email without converting the legacy email.

The set of revisions can include changes to the subject, changes to the body, changes to attachments, changes to participants, and responses to comments that create a comment thread.

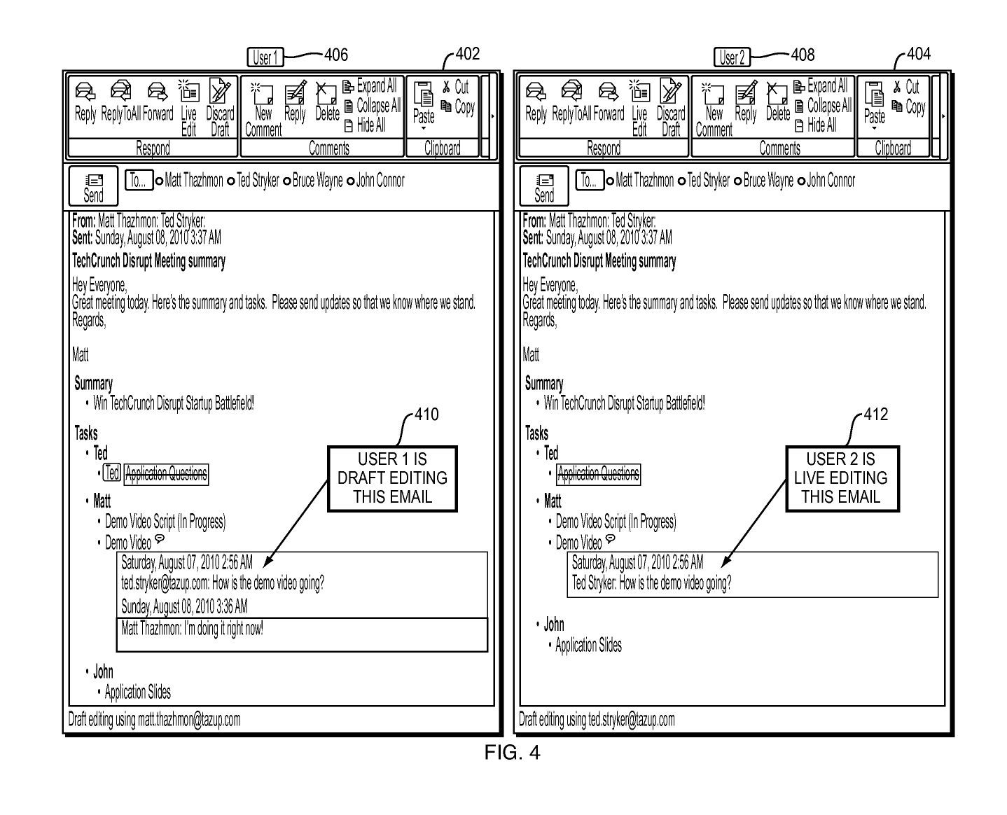

As shown in FIG. 4, exemplary user interfaces (UIs) 402, 404 illustrate a real time editing of an emails between a first user 406 and a second user 408. In this example, the first user 406 is draft editing 410 and the second user 408 is live editing 412.

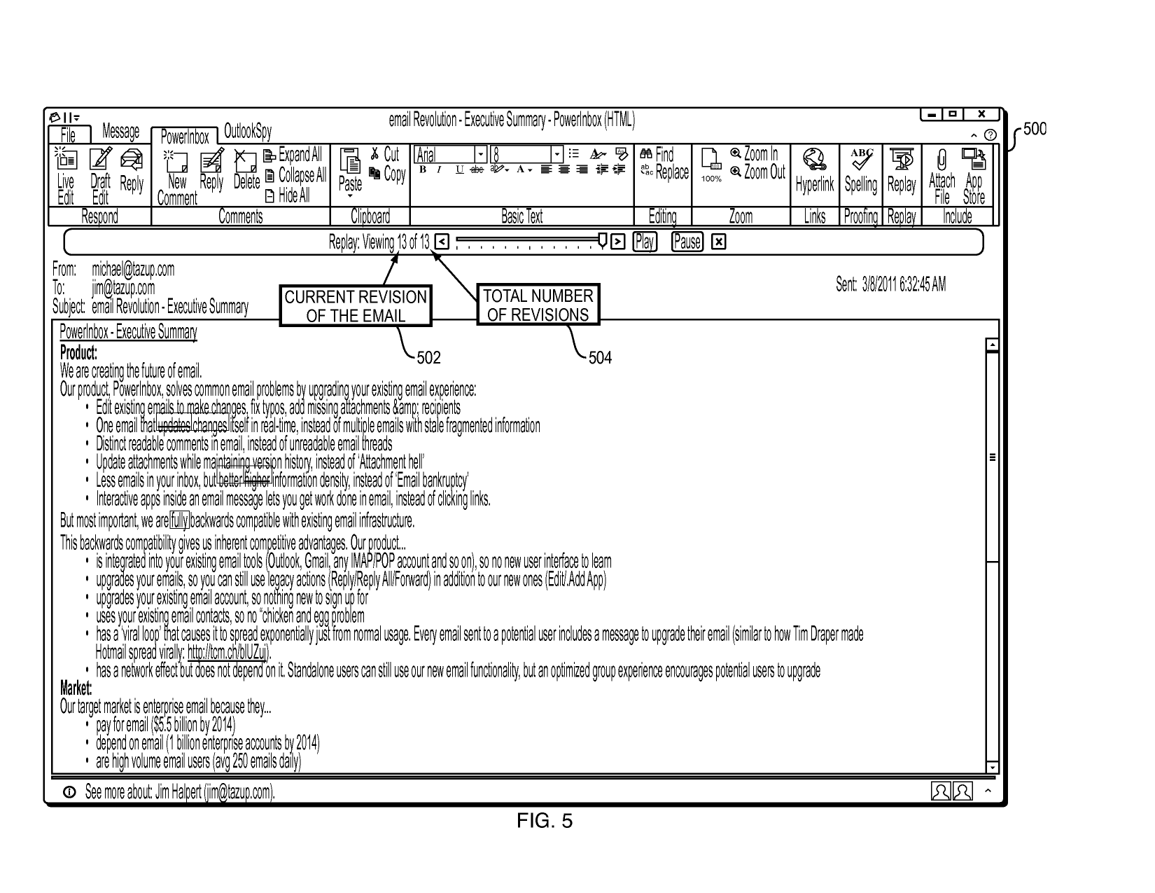

As shown in FIG. 5, an exemplary user UI 500 illustrates the visual aids to enable a user to replay viewing of an email message. The UI 500 includes visual indications of a current revision 502 and total number of revisions 504 of the email. Further buttons enable the user to go to the previous version of the email, go to the next version of the email, play all revisions of the email and pause the playback.

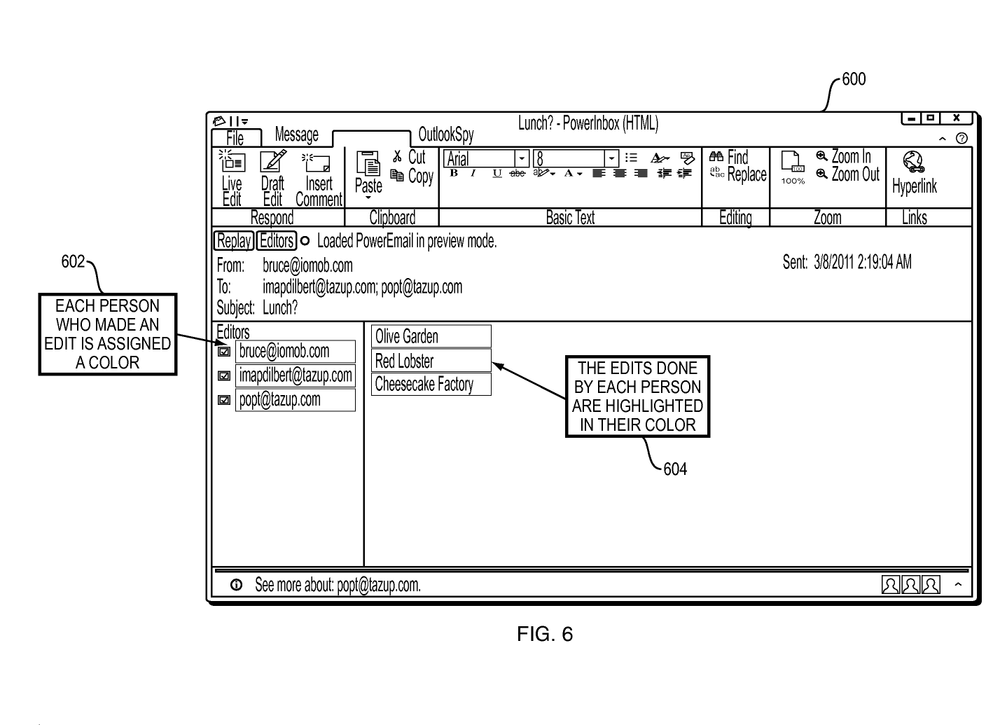

As shown in FIG. 6, an exemplary UI 600 illustrates how a user can view who said what in an email message. In this example, each person who has made an edit is assigned a color 602 and the edits done by each person are highlighted in their color 604.

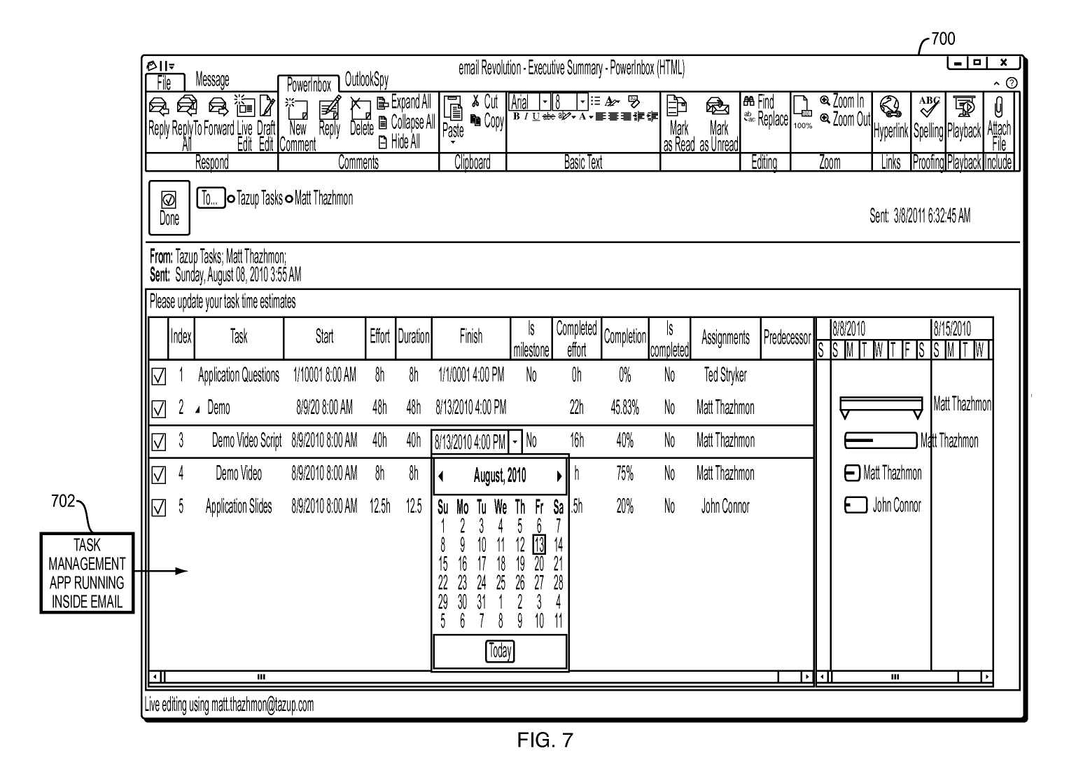

As shown in FIG. 7, an exemplary UI 700 illustrates how a user can have an application (app) running inside an email. In this example, a task management app 702 is running within the email and the user can interact with the app 702, such as updating a task estimate inside the email.

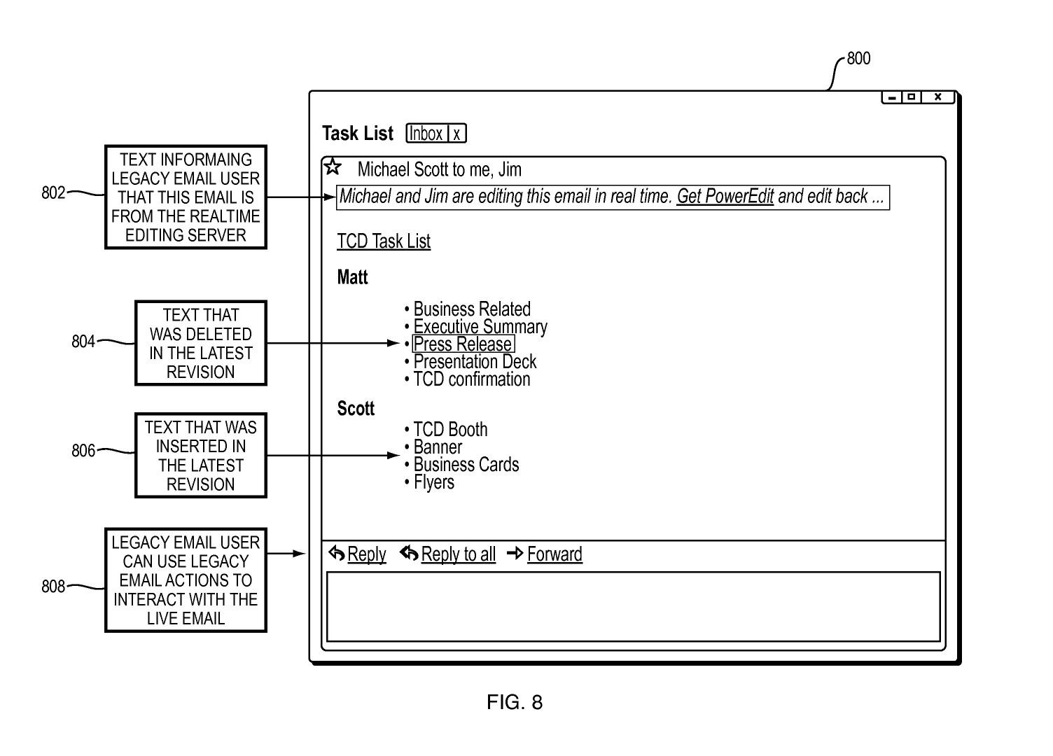

As shown in FIG. 8, an exemplary UI 800 illustrates how an email user with live edit capability can interact with an email user who does not have live edit capability, i.e., a legacy email user. In this example, a live edit email is converted to a legacy email and displayed to the email user who does not have live edit capability, along with text informing the legacy email user that this email is from a real time editing server 802, text that was deleted in the latest email revision 804, and text that was inserted in the latest email revision 806. The legacy email user can use legacy email actions (e.g., Reply, ReplyAll, Forward) to interact with the live email 808.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
in a network, establishing a session between an email client and an email server;
loading a legacy email message in the email client;
receiving a live edit selection or a draft edit selection;
converting contents of the legacy email message into a set of revisions;
sending the set of revisions to the email server with an identifier created using a hashing algorithm on parts of the legacy email message header and body;
comparing the identifier with current live emails to determine if the legacy email message has been edited previously;
if the identifier is not found, generating a new live email with a master revision line containing the initial set of revisions;
if the identifier is found, adding the revisions to a master revision line in the preexisting live email; and
sending the live email content back to the email client where it replaces the legacy email.

2. The method of claim 1 wherein receiving the live edit selection comprises:
displaying a live edit button on a dashboard on user interface adjacent to standard email buttons; and
receiving an indication that the live edit button has been selected.

3. The method of claim 1 wherein receiving the draft edit selection comprises:
displaying a draft edit button on a dashboard on user interface adjacent to standard email buttons; and
receiving an indication that the draft edit button has been selected.

4. The method of claim 1 wherein the revisions include a comment on a specific section of the legacy email.

5. The method of claim 4 wherein the comment is stored as a thread in a string of comments.

6. The method of claim 1 wherein the revisions include an inserted application.

7. The method of claim 6 where a recipient can view the inserted application.

8. The method of claim 1 wherein contents of the legacy email message comprise participants, subject, email header information, and rich text content of the legacy email.

9. The method of claim 1 wherein the email client comprises a real time editing client and the email server comprises a real time editing server.

10. The method of claim 9 wherein the real time editing client and the real time editing server are selected from the group consisting of addins, addons, plugins, code and code libraries.

11. The method of claim 9 wherein communication between the real time editing client and the real time editing server is over an application programming interface (API).

12. The method of claim 1 further comprising stepping through the revisions to display sequences of changes.

13. The method of claim 12 wherein stepping is either in a forward or a backward direction enabling display of a change history of the live email.

14. The method of claim 1 further comprising querying the email server for revisions to the live email based on version numbers.

15. The method of claim 1 further comprising:
maintaining a list of which versions of the live email have been viewed;
displaying changes that have been made to the live email since it was last viewed.

16. The method of claim 15 wherein the changes are highlighted.

17. The method of claim 15 wherein the changes originate from multiple participants.

18. The method of claim 1 wherein the email client comprises a real time editing client enabled to reply to the email and merge revisions into a real time version of the email.

19. The method of claim 9 further comprising transforming a revision into the legacy email and sending the legacy email to one or more recipients who do not have the realtime editing client.

20. The method of claim 19 further comprising merging a reply from a recipient of the email who does not have the realtime editing client into a real time version of the email.

21. The method of claim 1 further comprising generating a live email without converting the legacy email.

22. The method of claim 15 where in the changes include indications of participants who modified parts of an email.

23. The method of claim 15 wherein the changes include one or more limitations on an edit behavior of a recipient, the one or more limitations stored as metadata.

24. The method of claim 23 wherein the edit behavior is selected from the group consisting of one or more can edit and comment, one or more can only comment, one or more cannot hit ReplyAll, and one or more cannot do any modifications.

25. The method of claim 15 wherein the changes include change to participants of an email after it has been sent.

26. The method of claim 15 wherein the list is ordered by minute, hour, day, week, month, and year.

27. The method of claim 1 wherein the set of revisions are selected from the group consisting of changes to the subject, changes to the body, changes to attachments, changes to participants, and responses to comments that create a comment thread.
